(19) United States
(12) Patent Application Publication
(10) Pub. No.: US 2010/0100524 A1
(43) Pub. Date: Apr. 22, 2010

(54) APPROVAL SYSTEM IN NETWORK FOR THE DATA PRESERVATION

(76) Inventors: Hwan Kuk Bae, Seoul (KR); Yang Jin Seo, Seoul (KR); Sang Jin Kim, Seoul (KR)

Correspondence Address: IPLA P.A., 3550 WILSHIRE BLVD., 17TH FLOOR, LOS ANGELES, CA, 90010, US

(21) Appl. No.: 12/518,873

(22) PCT Filed: Dec. 11, 2007
(86) PCT No.: PCT/KR07/06451

§ 371 Date: Jun. 11, 2009

(30) Foreign Application Priority Data
Dec. 11, 2006 (KR) 10-2006-0125839

(51) Int. Cl. G06F 17/30; G06F 15/16

(52) U.S. Cl. 707/609; 709/203; 707/769; 707/E17.01; 707/783; 707/E17.014

(57) ABSTRACT

The present invention relates to an approval system in a network for data security. The approval system includes a management server (10), a plurality of client terminals (30, 30′ end 30″), having first and second client terminals, and a file server (20). The first client terminal includes a first approval module for outputting a first window that enables a first user to input a request for viewing an arbitrary document, and transmitting data input by the first user to the management server. The second client terminal includes a second approval module for outputting a second window. The management server includes an approval agent module for mediating communication of the data and the approval data between the first approval module and the second approval module, and for opening the arbitrary document to the first client terminal when the approval data contains information indicating allowance for viewing of the document.

### TECHNICAL FIELD

The present invention relates to an approval system in a network for data security, which controls access by a plurality of terminals or users to a file server that enables the terminals or users to share various types of information data, such as drawing files, image files, text files, moving image files, and Musical Instrument Digital Interface (MIDI) files.

### BACKGROUND ART

Since various types of information documents (hereinafter referred to as “documents”), such as drawing files, image files, text files, moving image files, and MIDI files, which are utilized in enterprises and government offices, must be able to be accessed and utilized by a plurality of users having relationships with the enterprises and government offices, the documents are stored in a file server and are then shared in an environment in which a plurality of client terminals is connected via the Web or a network.

FIG. 1 is a view showing communication between a management server, a file server and terminals in a Web or network environment. The following description will be given with reference to this drawing.

A system that is configured such that a plurality of users shares information while communicating with each other mainly includes a plurality of client terminals 30, 30′ and 30″ which communicate with each other via the Web or a network, and a management server 10 which is connected to the client terminals 30, 30′ and 30″ while managing the communication therebetween.

The management server 10 can control the communication between the client terminals 30, 30′ and 30″ and supervise communication with the outside for the purpose of security, and can store necessary documents and then provide documents in response to the request of the client terminals 30, 30′ and 30.″ Since the construction of the management server 10 is part of a widely-known conventional system, an additional description thereof will be omitted here.

Meanwhile, as the amount of information increases and the management thereof is considered more important, the specialized management of information has been required. Therefore, for conventional functions of the management server 10, a file sharing server 20 (hereinafter referred to as a file server) manages the operation of storing and managing information, and the management server 10 performs only the operations of performing communication control and security between the client terminals 30, 30′, and 30″.

However, the file server 20 may contain important confidential information, which must not be open to the public, in the documents thereof, in addition to information which can be open to the public. Therefore, in order to prevent the illegal leakage of confidential information, access to the file server, which contain confidential information in the documents thereof, can be made only through authorized client terminals 30, 30′, and 30″, so that the documents can be viewed only in the corresponding client terminals 30, 30′, and 30″.

Here, the term “view” collectively refers to ‘retrieving a document’, ‘viewing a document’, ‘editing a document’, and ‘transferring a document’.

However, in the conventional security method, access to the file server 20 can be made through the authorized client terminals 30, 30′, and 30″, and there is no difficulty of leaking stored documents after the access has been made. Furthermore, since no accurate data or evidence for the leaked documents remains, a problem occurs in that it is difficult to chase the user responsible for leaking the documents and the reliability of the results of the chase is low. In consequence, the conventional security method for a file server has a structure in which security for corresponding documents is determined depending on the awareness and determination of users who are authorized to access the file server 20.

That is, since the security of a network, including the management server 10, the file server 20, and the client terminals 30, 30′, and 30″, is determined depending on the intention of users, the reliability of security is low.

Meanwhile, in a conventional document sharing method for the file server, there are many cases where access to the file server 20 through authorized client terminals 30, 30′ and 30″ is uniformly limited. That is, when a user must access a document requiring security in order to conduct work, it is impossible to continue to transfer the work owing to uniformly limited user's rights, and it is necessary for the user to go to a lot of trouble to update a system, including the file server 20, after obtaining a manager's permission offline in order to gain authorization to access the document.

Consequently, since the user's ability to perform work is interrupted, the conventional document sharing method is plagued by various problems in practice.

### DISCLOSURE

### Technical Problem

Accordingly, the present invention has been made keeping in mind the above problems, and an object of the present invention is to provide an approval system in a network for data security, which can change the rights of an unqualified user while reliably maintaining the security of a relevant document without interfering with work when the unqualified user must access a document requiring security.

Another object of the present invention is to provide an approval system in a network for data security, which makes the access to or use of documents, stored in a file server shared by a plurality of client terminals, easy and improves the effectiveness of security, thus enabling the shared documents to be more securely and effectively used.

### Technical Solution

In order to accomplish the above objects, the present invention provides an approval system in a network for data security, the approval system including a management server, a plurality of client terminals, having first and second client terminals that communicate with the management server, and a file server storing documents shared by the plurality of first and second client terminals, wherein the first client terminal comprises a first approval module for outputting a first window that enables a first user to input a request for viewing an arbitrary document, and transmitting data input by the first user in the first window to the management server, the second client terminal comprises a second approval module for outputting a second window that displays the data received from the management server and transmitting approval data, which indicates whether to allow the first user to view the document and is input by a second user into the second window, to the management server; and the management server comprises an approval agent module for mediating communication of the data and the approval data between the first approval module and the second approval module, and for opening the arbitrary document to the first client terminal when the approval data contains information indicating allowance for viewing of the document.

### Advantageous Effects

Accordingly, the present invention is advantageous in that, in a system in which a management server and a client terminal communicate with each other, and a file server for storing various types of documents shares the documents with the management server and the client terminal while communicating with the management server and the client terminal, the right of a user to view the documents or the authorization limits for the documents are changed after quickly obtaining the approval of a superior, and the user can effectively view confidential documents required for work through the above-described change, thus enabling the flexible viewing of documents while reliably maintaining the security of documents in a limited document environment.

Moreover, the present invention is advantageous in that the authorization limits of access to shared documents are discriminated for respective users when a file server is accessed via a plurality of client terminals, so that document security can be managed in detail.

Furthermore, the present invention is advantageous in that, since a required document can be retrieved or searched for using a dedicated security explorer tool at the time of accessing a file server, a user can have an experience similar to that of working in a local area, so that the user can perform more stable and efficient work on documents.

In addition, the present invention is advantageous in that information files are placed in documents requiring security, or the documents requiring security are collected in a single document DB, and then access to the documents is controlled and managed for respective users, so that, even if two or more users simultaneously perform work on the same document, there is a small possibility of collision or corruption of a relevant document in question, and thus work on documents can be more securely performed.

### DESCRIPTION OF DRAWINGS

FIG. 1 is a diagram showing communication between a management server, a file server and terminals in a network environment;

FIG. 2 is a detailed block diagram showing the construction of FIG. 1 based on the approval system of the present invention;

FIG. 3 is a flowchart of an approval method sequentially showing the steps of accessing and viewing a document using the approval system of FIG. 2 according to the present invention;

FIG. 4 is a diagram showing an image for a screen on which the menu option of a file server security explorer tool is displayed in the GUI of Windows™ according to the present invention;

FIG. 5 is a diagram of a GUI image showing the running of a file server security explorer tool according to the present invention; and

FIG. 6 is a block diagram showing another embodiment of an approval system according to the present invention.

### MODE FOR INVENTION

Hereinafter, embodiments of the present invention will be described in detail with reference to the attached drawings.

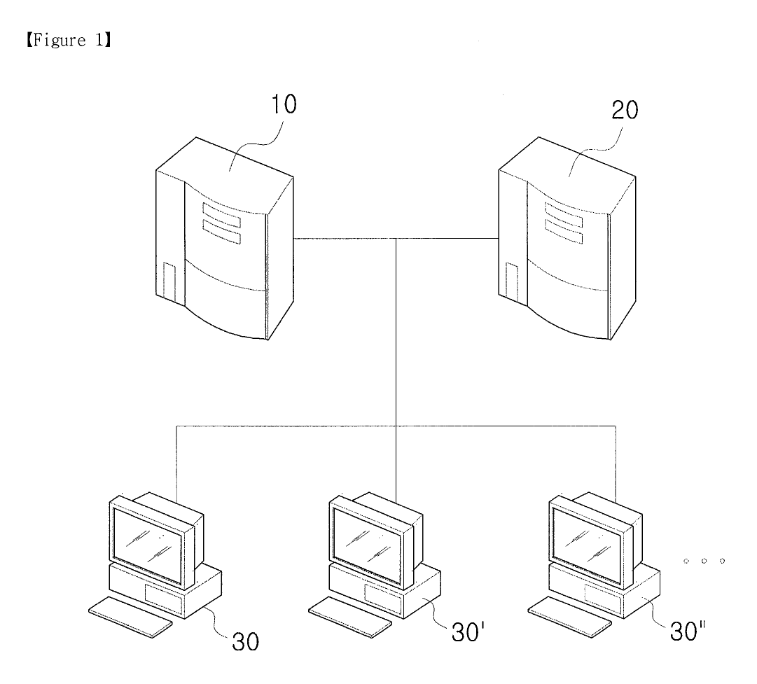

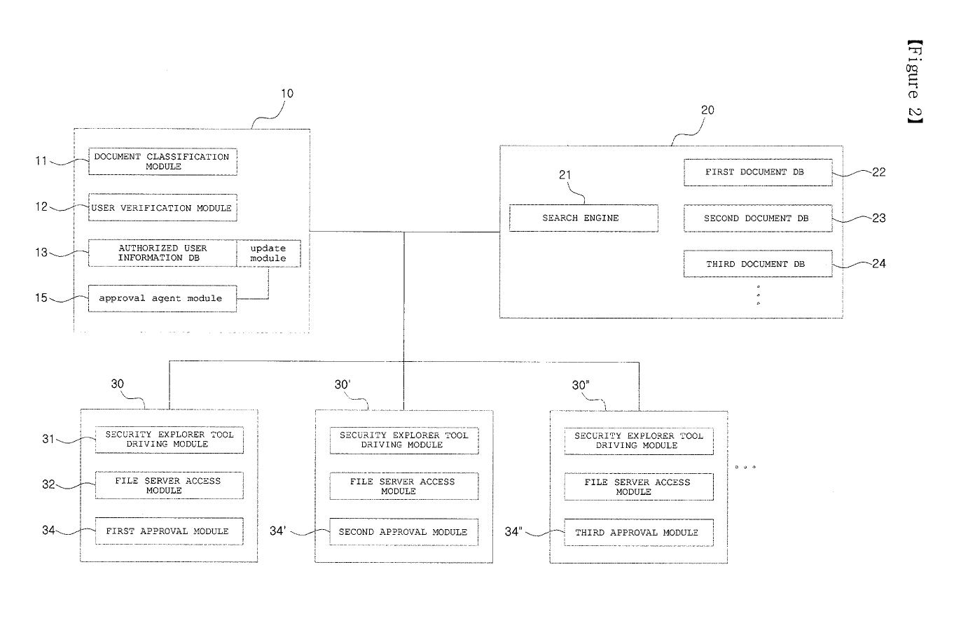

FIG. 2 is a detailed block diagram showing the construction of FIG. 1 based on the approval system of the present invention. The following description is given with reference to FIG. 2.

The approval system of the present invention is installed in, or applied to, a structure in which a management server 10, a file server 20, and a plurality of client terminals 30, 30′ and 30″, which are connected to the management server 10 and the file server 20 and communicate with each other via the Web or in a network environment, are included, and is configured to control the client terminals 30, 30′ and 30″, which access the file server 20, and to manage the viewing of the documents stored in the file server 20. Furthermore, the approval system is flexible enough to allow a user to view confidential documents by allowing the user's access rights to be rapidly changed through the client terminal 30, 30′ or 30″.

For this purpose, the management server 10 includes a user verification module 12 for identifying the users of the client terminals 30, 30′, and 30″, an authorized user information DB 13 for recording the information of the users, and a document classification module 11 for searching for and classifying the documents that are discriminately opened to respective users.

Meanwhile, the file server 20 includes a document Database (DB) for storing documents and a search engine 21 for managing/searching the document DB. The document DB may include two or more document DBs according to the circumstances.

For reference, the document DB includes a plurality of DB drives in the form of hardware, and is thus divided into a first document DB 22, a second document DB 23, a third document DB 24, etc. Alternatively, in a single device, the area of a disc is divided and is then classified into a first document DB 22, a second document DB 23, a third document DB 24, etc. The concept of a virtual disc can be applied to the latter case, which will be described in detail below.

Meanwhile, the client terminals 30, 30′ and 30″ are two or more in number, as shown in the drawing. Each of the client terminals 30, 30′ and 30″ includes a security explorer tool driving module 31 for controlling the operation of a security explorer tool, which is the management method of the approval system according to the present invention, and a file server access module 32, functioning as a procedure execution device for determining whether access to the file server 20 has been authorized.

A large number of documents stored in the file server 20 may be classified into typical public documents, which do not require security, and confidential documents, which require security. The opening of the confidential documents can be limited for respective users. That is, even if a plurality of users can access the file server 20 through the plurality of client terminals 30, 30′ and 30″, the viewing of specific documents can be completely or partially limited.

However, a user who is not authorized to view confidential documents may be required to view the confidential documents in order to conduct work, in various circumstances, or for various reasons.

For this purpose, the approval system of the present invention enables the authorization limits of a user for the documents stored in the file server 20 to be promptly and flexibly adjusted.

In order to facilitate the understanding of the technical spirit of the approval system according to the present invention, the process in which a user accesses the file server 20 using the client terminal 30, 30′ or 30″ and views documents stored in the file server 20 will be described below.

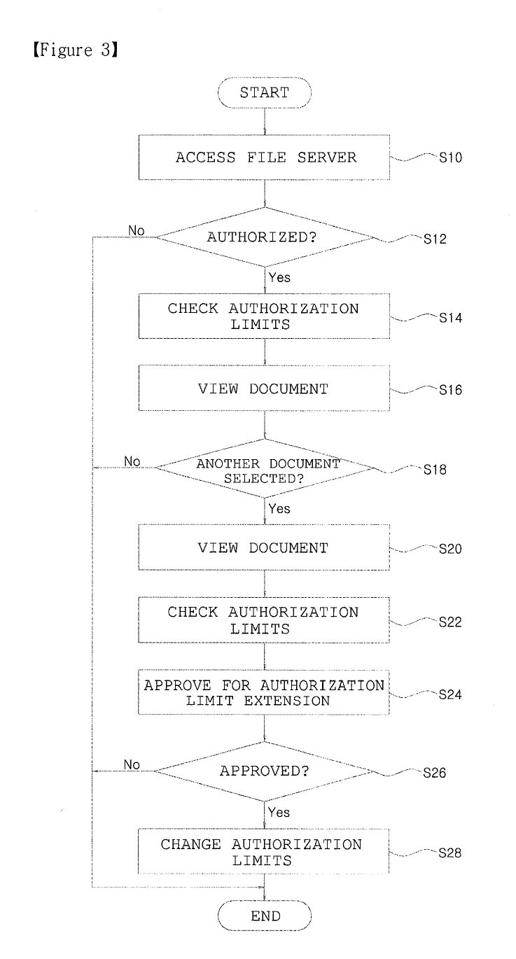

FIG. 3 is a flowchart of an approval method sequentially showing the steps of accessing and viewing a document using the approval system of FIG. 2 according to the present invention.

S10; File server access step

A user accesses the file server 20 through the client terminal 30, 30′ or 30″. In this case, the client terminal 30, 30′ or 30″ and the file server 20 can communicate with each other via the Web, or a limited network, such as a mobile local area network.

Although, in an embodiment of the present invention, the latter communication network, which is difficult for external users to access, is used for the communication between the client terminals 30, 30′ and 30″, the management server 10 and the file server 20, but the technical spirit of the present invention is not limited to this embodiment.

The user can access the file server 20 through an arbitrary client terminal 30, 30′ or 30″ using various methods. However, the approval system of the present invention uses the configuration of Windows Explorer to access the file server 20.

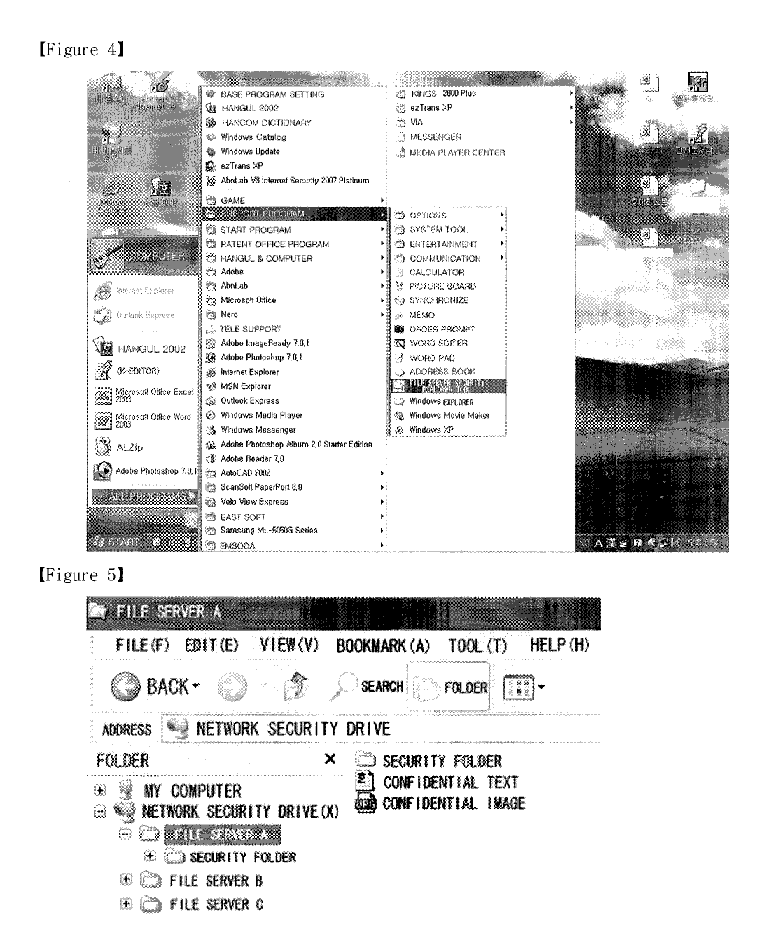

That is, as shown in FIG. 4 (an image showing the menu option of the file server security explorer tool according to the present invention, displayed in the Graphic User Interface [GUI] of Windows™), the “file server security explorer tool” of the approval system of the present invention is shown as being similar to the “Windows search tool”, so that the user who uses the client terminal 30, 30′ or 30″ can work while having an experience like the experience of searching for and opening a document on his or her local PC (client terminal).

Moreover, the security explorer tool of the present invention can also be implemented using a dll module, such as ‘Shell name extension’ or ‘ActiveX,’ in addition to the method similar to that of “Windows Explorer.”

Meanwhile, access to the file server 20 is not uniformly authorized without discriminating between the client terminals 30, 30′ and 30″. That is, one client terminal 30 can access the file server 20, and other client terminals 30′ and 30″ may be prohibited from accessing the file server 20. This is made possible by installing a file server access module 32, including an authentication file or the like, in the client terminal 30 that is capable of accessing the file server.

As shown in FIG. 4, in the case of the client terminal 30 in which the file server access module 32 is installed, the menu option of the “file server security explorer tool” can be seen, whereas, in the case of the client terminals 30′ and 30″ in which the file server access module 32 is not installed, the menu option cannot be seen.

However, since this is only one of various embodiments related to whether the menu option of the “file server security explorer tool” can be seen, the technical spirit of the present invention is not limited thereto (the “file server security explorer tool” may not be executed in the client terminal 30 incapable of accessing the file server even when the “file server security explorer tool” can be seen).

S12; Authorization verification step

When a user selects the menu option of the “file server security explorer tool”, the file server access module 32 verifies whether the currently running client terminal 30, 30′ or 30″ has been authenticated while communicating with the management server 10.

Thereafter, if the client terminal 30 is determined to be an authenticated terminal, the file server access module 32 outputs an ID/password input window, required to verify whether the user has been authorized.

However, the present invention is not limited thereto. That is, (1) whether to activate a security explorer tool can be determined by directly outputting an ID/password input window, required to verify whether a user has been authorized, and by verifying whether the current user has been authorized using the ID/password input into the input window without verifying whether the client terminal 30, 30′ or 30″ has been authenticated, and (2) whether to activate a security explorer tool can be determined by verifying through the file server whether the accessing client terminal 30, 30′ or 30″ has been authorized, and allowing the security explorer tool to be executed in the authorized client terminal 30, 30′ or 30″ without verifying the authorization of a user.

In the latter case, when a security explorer tool is executed in an unauthorized client terminal 30, 30′ or 30″, a window showing a message such as “access is denied” is displayed, thus informing the user that it is impossible to access the security explorer tool.

Although the authentication process can be performed using various embodiments, the technical spirit of the present process will be described through an embodiment using an ID and a password. Of course, the technical spirit of the present invention can be variously modified and implemented within a range that does not depart from the accompanying claims.

When the user inputs his or her II) and password to the input window, the file server access module 32 transmits the identification information (ID/password) to the user verification module 12 of the management server 10.

The user verification module 12 searches the authorized user information DB 13 for information that matches the identification information.

The authorized user information DB 13 may store various types of personal information, including users' identification information, and the user verification module 12 determines whether the user currently attempting to access the file server 20 is a user who has been authorized to access the file server 20 on the basis of the identification information.

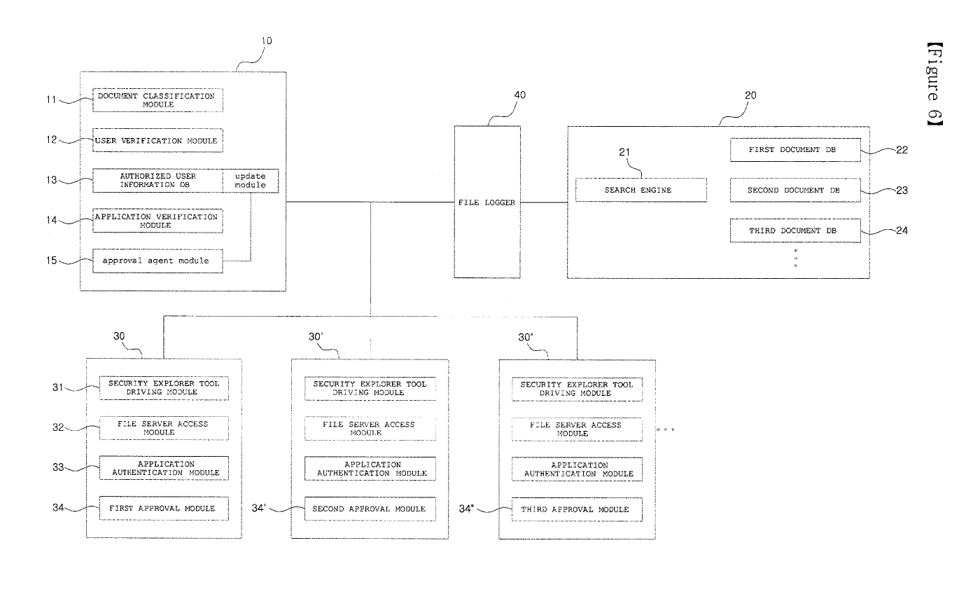

As a result of the determination by the user verification module 12, if the user is determined to be an unauthorized user, access by the user to the file server 20 is denied, whereas, if the user is determined to be an authorized user, the user verification module 12 transmits a driving signal to the security explorer tool driving module 31. Consequently, the security explorer tool driving module 31 activates the file server security explorer tool according to the present invention, thus allowing the user to access/search the file server in a method similar to the well-known method of using Windows Explorer, as shown in FIG. 5 (an image showing a GUI that shows the driving of the file server security explorer tool according to the present invention).

In the shown embodiment, a ‘network security drive’, which is a directory for the file server 20, is found using the security explorer tool, and a plurality of file servers A to C is included in the ‘network security drive’. The file servers A to C, which refer to the first, second and third document DBs 22, 23 and 24, respectively, can be configured such that some or all of the file servers A to C can be output depending on the identification of a user, and, through this, the user can access a relevant first, second or third document DB 22, 23 or 24 by clicking information about only a relevant file server.

Of course, since a user who is unauthorized to access the file server cannot find the ‘network security drive’ itself using the security explorer tool, it is impossible for such a user to access the file server 20.

S14; Authorization limits checking step

As described above, the approval system of the present invention can also discriminately allow access to documents for respective users who have been authorized to access the file server 20.

Of course, it is possible to show all documents stored in a relevant file server 20 to a user who has succeeded in accessing the file server 20, to determine whether the user has been authorized to view a selected document when the user selects any one from among the documents and attempts to view the document, and to allow or deny the user to view the document on the basis of the results of such a determination. However, in the embodiment of the present invention, documents output to the file server security explorer tool are first discriminated between for respective users, and are then output.

That is, it is possible for an arbitrary user to view all documents, the information of which is output to the file server security explorer tool.

For this purpose, in the present invention, the management server 10 further includes a document classification module 11.

The document classification module 11 checks a relevant user's rights by searching the authorized user information DB 13 in the user verification process performed by the user verification module 12, classifies accessible documents corresponding to the rights by searching the first, second and third document DBs 22, 23 and 24 using the search engine 21 of the file server 20, and transmits information about the classified documents to the client terminal 30 in conjunction with the operation of the security explorer tool driving module 31.

Even in the same department, in which a plurality of users forms a single team, authorization limits for viewing of documents can be differently set for respective users through the above-described classification of documents for respective users, so that there is an advantage in that the security of documents in the file server 20 can be precisely managed.

Meanwhile, in order to check a user's authorization limits for viewing documents and allow the user to access and view documents within the authorized limits, the storage device of the file server 20 can be implemented using various embodiments. Respective embodiments will be disclosed below.

In the file server 20, a plurality of first, second and third document DBs 22, 23 and 24 may be formed, and may store documents that have been classified according to security level. That is, the document classification module 11 checks the authorization limits of a specific user, and opens only one or more relevant document DBs. Consequently, only the documents in the opened document DBs are opened to the user's client terminal 30 through a security explorer tool.

Furthermore, an information file, in which data about a security level is recorded, is created for each document, so that only documents corresponding to a relevant user may be searched for and be opened to the user's client terminal 30.

However, the method in which the approval system according to the present invention opens documents only to the client terminal 30, 30′ or 30″ authorized to view the documents is merely one embodiment, and a method of opening all documents regardless of users and client terminals 30, 30′ and 30″ and allowing viewing to be performed within the authorization limits of the users and the client terminals 30, 30′ and 30″ may also be employed.

A detailed description of the immediately preceding embodiment will be made again with reference to a description of an approval agent module 15.

When only a single document DB is provided in the file server 20, and then it is impossible to classify and store documents for respective document DBs, the concept of a virtual disc is applied to the document DB, so that the document DB is divided into a plurality of document DBs. The document DBs resulting from such division are controlled such that authorization to access the document DBs is controlled differently for respective document DBs, thus realizing the same effect as that obtained when a plurality of first to third document DBs 22, 23 and 24 is provided, as described above.

However, the application of the concept of a virtual disc to the file server 20 is only an embodiment for implementing the file server 20, which is one component of the system according to the present invention, and the following embodiments, other than the application of the concept of a virtual disc, can be realized.

The file server 20 has the same structure as a typical file server, verifies a client terminal 30, 30′ or 30″ or a user through the user verification module 12, and allows only an authorized client terminal 30, 30′ or 30″ or an authorized user to access the file server 20. Therefore, an indication of a drive, showing the file server 20, is output to a relevant client terminal 30, 30′ or 30″ regardless of whether authorization has been granted, thus allowing the user to be aware of the presence of the file server 20 through the indication of the drive. When an authorized user attempts to access the file server 20, the access is granted, whereas, when an unauthorized user attempts to access the file server 20, a window showing a message, such as “access is denied” is output, thereby notifying the current user that access to the security explorer tool is impossible.

However, it is also possible to prevent an unauthorized user from being aware of the presence of the file server 20 itself by differently setting an indication of a drive for respective the client terminals 30, 30′ and 30″ according to whether authorization has been granted.

An embodiment in which a virtual disk is applied to the file server 20 according to the present invention will be described below.

Since the concept of a virtual disk is described in detail in “Access Control System for Respective Application Programs using Virtual Disk and Method of Controlling the Same (Korean Patent No. 10-0596135)” which was filed and the patent rights of which is possessed by the present applicant, a description of a virtual disk will be omitted. A description of the application of the virtual disk to the present invention will be described below.

A virtual disk, defined in “Access Control System for Respective Application Programs using Virtual Disk and Method of Controlling the Same (hereinafter referred to as ‘prior art invention’)”, is installed in a hard disk (although a hard disk is considered to be a simple data storage recording device in a general-purpose local PC, the hard disk may be called a DB and may be considered to be a DB in the case of a server connected to clients via a network or the Internet. Therefore, in the present invention, a hard disk, which is a space to which a virtual disk is applied, includes not only the hard disk of a general-purpose PC but also the DB of a server. Here, the DB is a file server), and is configured to classify applications that attempt to access the virtual disk into an authorized application module and an unauthorized application module and controls the access of the application modules. In the present invention, a virtual disk is installed in the file server, and whether the client terminals and users that attempt to access the file server have been authorized is checked, thereby controlling access to the file server.

That is, when the security explorer tool driving module 31 verifies a user and then drives the security explorer tool, only one or more virtual disk drives corresponding to the authorization limits of the verified user are output within the security explorer tool so as for the user to access them. Of course, in the case in which the user's authorization limits for access does not include a specific virtual disk drive, the security explorer tool does not output the virtual disk drive.

In brief, if, in the prior art invention, for example, a security file stored in a virtual disk should be retrieved so as for an authorized application to perform work, the authorized application can detect the security file by executing a retrieval function (the case of a Windows system is an example). Since this is a retrieval function executed by the authorized application, the security file is considered to be a file stored in a separate drive (the virtual disk is recognized as a separate drive by the Operating System (OS)) and is easily found and retrieved. However, in the case of an unauthorized application, the security file cannot be retrieved even if the retrieval function is executed because the corresponding drive does not exist as a target for retrieval. That is, the OS recognizes the virtual disk not as a separate drive but as a single file.

As described above, the approval system according to the present invention includes a plurality of virtual disks, and classifies them into first, second, third document DBs 22, 23, and 24, and verifies the authorization limits of a user who attempted access, so that only the document DBs authorized for the corresponding user are recognized as independent drives in the security explorer tool.

Meanwhile, after a user accesses a document DB, the user can store one or more documents stored in the document DB using respective ‘other names’ while viewing the documents. That is, the documents can be stored in another document DB or in a user's client terminal 30, 30′, or 30″, which is a local area, instead of the file server 20.

This also can be restricted using a virtual disk function. That is, the user, who retrieves a document from the first document DB 22 and is performing work on it, can retrieve documents stored in the second and third document DBs 23 and 24 (in the case in which the corresponding user has been authorized to access documents stored in the second and third document DBs) and view them, but cannot edit or store them. Of course, the user can retrieve the stored documents to his or her client terminal, which is a local area and view them, but cannot edit or store them.

Therefore, after the user closes the document of the first document DB 22 and then disconnects the first document DB 22, the user can retrieve other documents from the second and third document DBs 23 and 24, and then can view, edit, or store them.

S16: Document viewing step

A user accesses the file server through the file server security explorer tool, and views one or more desired documents.

If access to the file server 20 has been authorized, the user is authorized to view one or more documents stored in the document DB. Here, the view is classified as view which allows only ‘opening a document’, as view which allows ‘opening a document’ and ‘editing a document’, and as view which allows ‘opening a document’, ‘editing a document’, and ‘transferring a document’. That is, for the same document, the usage methods thereof can be divided according to the authorization limits of respective users.

For this purpose, the authorization limits of respective users for documents are also recorded in the authorized user information DB 13. When a document is provided to a user, an information file is associated with the document based on the record of the corresponding user, so that the user can view and process the document according to on his or her authorization limits.

Thereafter, when a plurality of users simultaneously attempts to access a document, stored in the file server, through different client terminals 30, 30′, and 30″, the approval system according to the present invention performs processes of verifying whether the user has been authorized to access the document and encrypting/encrypting the corresponding document at the level of a document DB, which stores the document, rather than at the level of an individual document. Therefore, even if the plurality of users attempts to access a single document, the possibilities of collision for document processing between users, damage to the document attributable to the collision, and incorrect operation attributable to the performance of encryption/decryption are minimized, thereby realizing a more stable system.

That is, the file server according to the present invention stores documents in a general file form, on which encryption is not performed, but performs encryption only on a process of accessing the file server. Therefore, when an authorized client terminal or a user attempts access, and thus connection between the file server and the authorized client is realized, the authorized client terminal or the user can access and view necessary documents as usual, as when viewing documents, without performing a separate procedure or process.

S18; Another document selection determination step

After viewing the document stored in the file server 20 through the above process, the user can attempt to view another document. This is simply performed by clicking the icon or name of another document output through the security explorer tool.

S20; Document selection step

The user accesses the file server 20 through the client terminal 30, 30′ or 30″ and searches the file server 20 for a desired document. In the above description, a means used to access the file server 20 and search for a document is implemented using a security explorer tool, but an approval operation, performed using the approval agent module 15, which will be described below, is not necessarily performed, on the assumption that the security explorer tool is used.

However, in the following description, embodiments of the approval system using the security explorer tool are successively described, and the definite scope of the present invention will be defined by the accompanying [claims].

Next, the user checks documents, stored in the file server 20, using the security explorer tool and determines whether to view a relevant document. However, in the above-described embodiments, the security explorer tool opens only documents that the user can view, thus preventing the user from accessing unauthorized documents at the outset. However, this is only an embodiment of the present invention, and it is also possible to open the titles or icons of unauthorized documents to the user.

Therefore, embodiments of the approval system according to the present invention will be described on the assumption that the following steps are performed on the condition that even unauthorized documents are opened to a user.

S22; Document viewing range checking step

The user checks his or her viewing range for a relevant document. That is, whether the user can open, edit, or transfer a selected document is determined.

This step is described in detail below. The user's rights to view a specific document are restricted and discriminately assigned according to his or her position, rank or requirement to conduct work. Therefore, the user can check his or her viewing range for the specific document by clicking the icon or name of the document that is opened through the client terminal 30, 30′ or 30″.

The checking of a document viewing range can be performed using various methods. Several embodiments thereof will be described in detail below.

(1) All documents stored in the file server 20 are opened regardless of the classification of document DBs, and thus the user can check his or her viewing range for each document.

(2) Documents stored in the file server 20 are classified into document DBs, and thus the user can check his or her viewing range for the documents stored in each document DB for which the user has access rights.

(3) Documents stored in the file server 20 are classified into respective document DBs, and thus the user can check a document DB for which the user has access rights. In this case, the user can access all documents present in the document DB. However, it is apparent that, even in the case of the documents present in the same document DB, the rights of respective users to view the documents can be discriminately assigned.

S24; Authorization limit extension approval step

The user may need to view or access documents or document DBs. However, in order for the user to view documents for which he or she does not have rights in the file server for which viewing and access are uniformly controlled, the overall processing of the system must be executed, and a lot of work must be performed offline.

However, in the case where work must be promptly conducted, there is a heavy burden in that a user in charge of work spends a lot of time viewing documents for which he or she does not have viewing rights.

Therefore, when there is a need to view or access unauthorized documents or document DBs, the user's viewing rights can be updated for a short period or a long period after obtaining a superior's approval.

The approval system of the present invention may include approval modules for processing approval between users and superiors, and an approval agent module 15, and may further include an update module 16 for updating the authorized user information DB 13.

The approval modules are installed in the client terminals 30, 30′ and 30″ and are called first, second and third approval modules 34, 34′, and 34″. Each of the first, second and third approval modules 34, 34′ and 34″ is the control device of an application for guiding a user through requesting approval and a superior through giving approval using a well-known method, such as an electronic signature. The first, second or third approval module 34, 34′ or 34″ is configured to record the information of the user of each client terminal 30, 30′ or 30″, and verify the user by checking the recorded user information at the time of running the first, second or third approval module 34, 34′ or 34″, or to verify the user by checking the ID/password, input by the user, to run a security explorer tool.

Meanwhile, the communication and control of the first, second and third approval modules 34, 34′ and 34″ are performed by the approval agent module 15 of the management server 10.

The approval method according to the present invention is sequentially described (including the approval step S26).

(1) The user can request that a superior extend the user's rights for a document, for which the user does not have viewing rights, among the documents checked at the document viewing range checking step S22.

For this purpose, the first approval module 34, provided in the client terminal 30 of the user, is run.

(2) Although the running of the first approval module 34 can be performed in various forms in the client terminal 30, an embodiment of the present invention uses a method of displaying a pop-up window.

That is, if it is determined that the user does not have viewing rights for a relevant document or that a required document is located in a document DB that is inaccessible to the user when the user accesses the file server 20 and checks the required document, the user runs the first approval module 32 to view or access the document or the document DB. The running of the first approval module 34 is performed by outputting a pop-up window, which enables the extension of the authorization limits and viewing rights of the user to be set and commanded, to the client terminal 30.

(3) The user inputs information about a document or a document DB, desired to be viewed or accessed, according to the display format of the pop-up window. In the case of a document, a GUI configuration, through which the range of viewing can be input, may be added to the pop-up window. Here, the viewing range is a range indicating whether ‘open’, ‘edit’ and ‘transfer’ is possible. When the user has only the right to ‘open’ the document, the user can request the right to ‘edit’ or ‘transfer’ the document to conduct work through the GUI configuration.

(4) The approval agent module 15 receives data about the extension of the user's authorization limits and viewing rights from the first approval module 34, checks the user's superior, and transmits the received data to the superior's client terminal 30′.

Here, the superior may be an administrator for a document desired to be viewed by the user, or may be the user's superior in rank.

(5) The data received from the approval agent module 15 is received by the second approval module 34′, which is installed in the superior's client terminal 30′. The second approval module 34′ displays a pop-up window on the client terminal 30′ to allow the superior to check the details of the data.

(6) The superior verifies the identity of the user requesting approval, and the request details, that is, details about the change of the user's rights to view or access a document or a document DB, in the pop-up window displayed on the client terminal 30′, determines whether to change the user's viewing rights or access, and makes approval or denial on the basis of the determination. The approval or denial can be made using an electronic signature, or can be simply made by selecting “Yes” or “No” in the case of a reliable client terminal 30′.

(7) Meanwhile, when the superior is not a person having the highest authority of decision, the superior can request approval from his or her superior (hereinafter referred to as a ‘highest superior’) with reference to the request details of the user. Therefore, in order to obtain approval from the highest superior, the superior confirms his or her approval, and then transmits resultant data to the approval agent module 15. The approval agent module 15 transmits the resultant data to the highest superior's client terminal 30.″

(8) The third approval module 34″ installed in the client terminal 30″ receives the resultant data, and displays a pop-up window using the same method as described above, thereby enabling the highest superior to check the details to be approved or denied.

(9) The highest superior checks the details to be approved or denied, approves or denies the details through the above-described method, and transmits the final resultant data to the approval agent module 15.

S28; Authorization limit change step

When the approval agent module 15 receives the final resultant data from the highest superior, the information of the user stored in the authorized user information DB 13 is changed/updated for a short period or a predetermined period by the update module 16 on the basis of the results of the approval.

That is, as the recording of the user's authorization limits and viewing rights is changed by the update module 16, the document classification module 11 allows the user to view or access a document or a document DB on the basis of the updated authorized user information DB 13.

FIG. 6 is a block diagram showing an approval system according to another embodiment of the present invention. The following description will be given with reference to this drawing.

The approval system according to the present invention further includes a file logger 40.

The file logger 40 stores the history of viewing of a document when a user accesses the file server 20 and views the document. That is, the file logger 40 records a user, a client terminal 30, 30′ or 30″ used by the user, the time at which access to the file server was made, a viewed document, and a document DB in which the document is stored.

Further, when a document stored in a document DB is viewed by a user and then the information of the document is newly updated through an editing process or the like, an original document, which is not updated, is stored in the file logger 40 so as to preserve the original of the corresponding document.

The record in the file logger 40 is used as information which is used for post inspection or is used to detect a leakage path when a document is leaked.

Meanwhile, an approval system according to another embodiment of the present invention includes an application authentication module 33 for verifying whether an application that opens one or more documents stored in the file server 20 has been authorized, and an application verification module 14 for verifying whether an application, installed in a currently accessed client terminal 30, 30′, or 30″, has been authorized while communicating with the application authentication module 33.

For example, even if a client terminal 30, 30′ or 30″, in which a Computer-Aided Design (CAD) program (application) capable of executing a “*.dwg” format file (document) is installed, can normally access the corresponding file server 20 and view the “*.dwg” format file, the corresponding “*.dwg” format file cannot be opened if the CAD program has not been authorized.

For this purpose, an authentication file is installed in an application authorized to access the file server 20, and an authentication verification file corresponding to the authentication file is installed in the application verification module 14. When an arbitrary application is run, whether the application has been authorized to access the file server 20 is verified. If, as the result of the verification of the application verification module 14, it is determined that the corresponding application has been authorized to access the file server 20, the security explorer tool driving module 31 is run normally and thus allows a user to search the file server 20 for documents.

Even when encryption/decryption is performed on a document stored in the file server 20 at the level of a document rather than at the level of a document DB, the operation of encrypting/decrypting the document is performed without requiring additional operation by the users in the case in which an authorized client terminal 30, an authorized user, and an authorized application attempt to open the corresponding document. Therefore, a problem of collision between operations, attributable to the encryption/decryption of respective users, can be solved even if two or more users simultaneously access and attempt to open a corresponding document.

1. An approval system in a network for data security, the approval system including a management server, a plurality of client terminals, having first and second client terminals that communicate with the management server, and a file server storing documents shared by the plurality of first and second client terminals, wherein:
the first client terminal comprises a first approval module for outputting a first window that enables a first user to input a request for viewing an arbitrary document, and transmitting data input by the first user in the first window to the management server;
the second client terminal comprises a second approval module for outputting a second window that displays the data received from the management server and transmitting approval data, which indicates whether to allow the first user to view the document and is input by a second user into the second window, to the management server; and
the management server comprises an approval agent module for mediating communication of the data and the approval data between the first approval module and the second approval module, and for opening the arbitrary document to the first client terminal when the approval data contains information indicating allowance for viewing of the document.

2. The approval system according to claim 1, wherein:
the first and second terminals comprise respective file server access modules that verify first and second users who attempt to access the file server, and security explorer tool driving modules that output a document stored in the file server if the file server access modules determine that the first and second users have rights to access the file server; and
the management server comprises an authorized user information DB that stores authorization information, indicating whether the first or second user can access the file server, and information about authorization limits accessible to the first or second user, a user verification module that checks information of the first or second user transmitted from the file server access module and searches for authorization information stored in the authorized user information DB, and a document classification module that searches the file server for documents falling within authorization limits of the first or second user on a basis of the authorization information transmitted from the user verification module, transmits information about the documents to the security explorer tool driving module. and enables the security explorer tool driving module to restrict access to documents viewed through the first or second client terminal according to the first or second user.

3. The approval system according to claim 2, wherein:
the first and second client terminals further comprise respective application authentication modules that read authentication files installed in executable applications; and
the management server further comprises an application verification module that controls execution of the security explorer tool driving module by checking the authentication files from the application authentication modules.

4. The approval system according to claim 2, wherein the management server further comprises an update module that updates information stored in the authorized user information DB so that, in a case where the approval agent module allows the first user to view a specific document, the first user can open and view the document through the security explorer tool when the first user subsequently accesses the file server.

5. The approval system according to claim 3, wherein the management server further comprises an update module that updates information stored in the authorized user information DB so that, in a case where the approval agent module allows the first user to view a specific document, the first user can open and view the document through the security explorer tool when the first user subsequently accesses the file server.
